(19) United States
(12) Patent Application Publication
(10) Pub. No.: US 2025/0296639 A1
(43) Pub. Date: Sep. 25, 2025

(54) STEERING DEVICE SUPPORT STRUCTURE

(71) Applicant: TOYOTA JIDOSHA KABUSHIKI KAISHA, Toyota-shi (JP)

(72) Inventors: Yuma FURUTA, Toyota-shi (JP); Takayoshi SHIGIHARA, Toyota-shi (JP)

(73) Assignee: TOYOTA JIDOSHA KABUSHIKI KAISHA, Toyota-shi (JP)

(21) Appl. No.: 19/027,135

(22) Filed: Jan. 17, 2025

(30) Foreign Application Priority Data
Mar. 21, 2024 (JP) 2024-045515

(51) Int. Cl. B62D 25/14; B60R 21/00; B60R 21/206; B62D 1/16; B62D 25/08

(52) U.S. Cl. CPC B62D 25/145; B60R 21/206; B62D 1/16; B62D 25/081; B60R 2021/0051

(57) ABSTRACT

The vehicle includes: an instrument panel reinforcement made of resin that includes a support portion that supports a steering column disposed on the vehicle front side of the driver's seat S; an extension portion that is integrally provided with the support portion and is supported by the vehicle body on the vehicle upper side of the support portion; an extension portion that is integrally provided with the support portion and is supported by the vehicle body on the vehicle lower side of the support portion; and an extension portion that is integrally provided with the support portion and is supported by the vehicle body on the vehicle width direction outer side of the support portion.

### CROSS-REFERENCE TO RELATED APPLICATION

This application claims priority to Japanese Patent Application No. 2024-045515 filed on Mar. 21, 2024, incorporated herein by reference in its entirety.

### BACKGROUND

### 1. Technical Field

The present disclosure relates to a steering device support structure.

### 2. Description of Related Art

Japanese Unexamined Patent Application Publication No. 2013-23045 (JP 2013-23045 A) discloses an disclosure related to a vehicle body structure. In the vehicle body structure, a steering device that includes a steering wheel is supported by an instrument panel reinforcement.

### SUMMARY

Incidentally, in the prior art, a support member is interposed between the steering device and the instrument panel reinforcement or between the instrument panel reinforcement and the vehicle body, and there is room for improvement from the viewpoint of reducing the number of components.

In view of the circumstances, the present disclosure has an objective to obtain a steering device supporting structure that can reduce the number of components required for support of a steering device.

A steering device support structure relating to a first aspect includes an instrument panel reinforcement made of resin. The instrument panel reinforcement includes a first support portion that supports a steering column arranged on a vehicle front side of a driver's seat of a battery electric vehicle,
a second support portion integrally provided with the first support portion and supported by a vehicle body of the battery electric vehicle on a vehicle upper side of the first support portion,
a third support portion integrally provided with the first support portion and supported by the vehicle body on a vehicle lower side of the first support portion, and
a fourth support portion integrally provided with the first support portion and supported by the vehicle body on a vehicle width direction outer side of the first support portion.

According to the steering device support structure relating to the first aspect, the steering device support structure includes an instrument panel reinforcement that includes a first support portion, a second support portion, a third support portion, and a fourth support portion.

In detail, the first support portion supports a steering column arranged on a vehicle front side of a driver's seat of a battery electric vehicle. Moreover, the second support portion is integrally provided with the first support portion and is supported by a vehicle body of the battery electric vehicle on a vehicle upper side of the first support portion. Moreover, the third support portion is integrally provided with the first support portion and is supported by the vehicle body on a vehicle lower side of the first support portion. Also, the fourth support portion is integrally provided with the first support portion and is supported by the vehicle body on a vehicle width direction outer side of the first support portion.

In this way, in the present aspect, the steering column can be supported with respect to the vehicle body by the instrument panel reinforcement.

A steering device supporting structure relating to a second aspect has, in the steering device supporting structure relating to the first aspect, the instrument panel reinforcement made of resin.

According to the steering device support structure of the second aspect, since the instrument panel reinforcement is made of resin, the cost of manufacturing the instrument panel reinforcement can be reduced, compared to a configuration such as forming the instrument panel reinforcement with a configuration made of metal.

In a steering device support structure relating to a third aspect, in the steering device support structure relating to the first aspect, the instrument panel reinforcement further includes an extension portion that extends from the first support portion to an opposite side to the fourth support portion and is supported by the vehicle body, and an airbag device is supported by a fifth support portion extended from the first support portion.

According to the steering device support structure relating to the third aspect, the fourth support portion and the extension portion extended to an opposite side to the fourth support portion are supported by the vehicle body, and the instrument panel reinforcement is in a bridged state in a vehicle width direction with respect to the vehicle body. Moreover, in the present aspect, the fifth support portion extends from the first support portion, and the airbag device is supported by the fifth extension portion.

Accordingly, in the present aspect, a reaction force at the time of deployment of the airbag can be supported by the vehicle body through the instrument panel reinforcement, and the number of components required for support of the airbag device can be reduced.

A steering device support structure relating to a fourth aspect has, in the steering device support structure relating to the first aspect, the second support portion supported by a cowl skeleton portion that constitutes a portion of the vehicle body, the third support portion supported by a dash panel that constitutes a portion of the vehicle body, the fourth support portion supported by a first pillar portion that constitutes a portion of the vehicle body, and the extension portion supported by a second pillar portion that constitutes a portion of the vehicle body and is positioned on an opposite side to the first pillar portion in a vehicle width direction.

According to the steering device support structure relating to the fourth aspect, the instrument panel reinforcement can be supported by a portion that has high rigidity in the vehicle body, namely, the cowl skeleton portion, the dash panel, the first pillar portion, and the second pillar portion positioned on an opposite side to the first pillar portion in a vehicle width direction. Accordingly, in the present aspect, a reaction force against an input to the steering wheel can be secured.

As described, the steering device support structure relating to the present disclosure has an excellent effect that can reduce the number of components required for support of a steering device.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view schematically illustrating a configuration of a vehicle front side portion of a vehicle to which a steering device support structure according to the present embodiment is applied;

FIG. 2 is a perspective view schematically showing a configuration around a steering device in a vehicle to which the steering device support structure according to the present embodiment is applied;

FIG. 3 is a front view schematically illustrating a relation between an instrument panel reinforcement and a dash panel in a vehicle to which a steering device supporting structure according to the present embodiment is applied; and

FIG. 4 is a perspective view schematically illustrating a relationship between the instrument panel reinforcement and the airbag device in the vehicle to which the steering device support structure according to the present embodiment is applied.

### DETAILED DESCRIPTION OF EMBODIMENTS

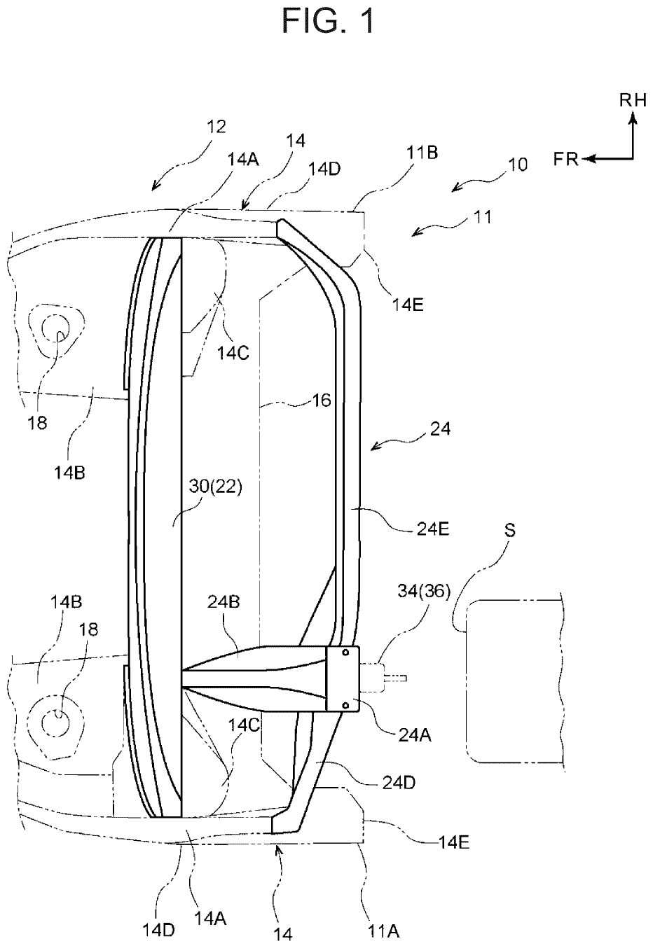

Hereinafter, an example of an embodiment of a steering device support structure according to the present disclosure will be described with reference to FIG. 1 to FIG. 4. Note that an arrow FR appropriately shown in the drawings indicates the front side of the vehicle, an arrow UP indicates the upper side of the vehicle, and an arrow RH indicates the right side in the vehicle width-direction.

First, a schematic configuration of a “vehicle 10” to which the steering device support structure according to the present embodiment is applied will be described with reference to FIG. 1.

The “vehicle body 11” of the vehicle 10 constitutes a front part 12 made of aluminum die cast which constitutes a part on the front side of the vehicle, and a central part in the vehicle front-rear direction. In addition, a center part (not shown) including a battery and a battery frame holding the battery, and a rear part (not shown) made of aluminum die cast constituting a part on the rear side of the vehicle are provided. That is, the vehicle 10 is a battery electric vehicle.

The front part 12 includes a pair of side components 14 and a connecting portion 16 that connects the side components 14 to each other in the vehicle width direction.

Specifically, the side components 14 each include an apron upper member portion 14A, a suspension tower portion 14B, a wheel house portion 14C, a side member portion 14D, and a lower pillar portion 14E.

The apron upper member portion 14A constitutes an upper edge portion of the side component 14 and extends in the front-rear direction of the vehicle. A suspension tower portion 14B and a wheel house portion 14C are provided below the apron upper member portion 14A in series with the apron upper member portion 14A.

The suspension tower portion 14B has a box shape in which a lower side of the vehicle is opened and a circular through portion 18 is formed on an upper surface thereof, and supports a shock absorber (not shown).

The wheel house portion 14C is provided integrally with the suspension tower portion 14B and has a spherical shape capable of accommodating a part of a tire (not shown).

The side member portion 14D is disposed on the vehicle lower side of the suspension tower portion 14B and is integrally provided with the suspension tower portion 14B and the wheel house portion 14C, and extends in the vehicle front-rear direction. A crash box (not shown) is attached to the front side of the side member portion 14D.

The lower pillar portion 14E constitutes a portion of the side component 14 on the vehicle rear side, and extends in the vehicle up-down direction. The lower pillar portion 14E on the left side in the vehicle width direction constitutes a portion on the vehicle lower side of the “front pillar portion 11A” as the first pillar portion on the left side in the vehicle width direction. The lower pillar portion 14E on the right side in the vehicle width direction constitutes a portion on the vehicle lower side of the “front pillar portion 11B” as the second pillar portion on the right side in the vehicle width direction.

On the other hand, the connecting portion 16 extends in the vehicle vertical direction and the vehicle width direction with the thickness direction being the vehicle front-rear direction, and is disposed along the front edge portion of the above-described center part. A vehicle cabin and a power unit room are partitioned together with a dash panel 20 to be described later.

A “dash panel 20”, a “cowl portion 22” as a cowl skeleton portion, and an “instrument panel reinforcement 24” are attached to the front part 12 configured as described above.

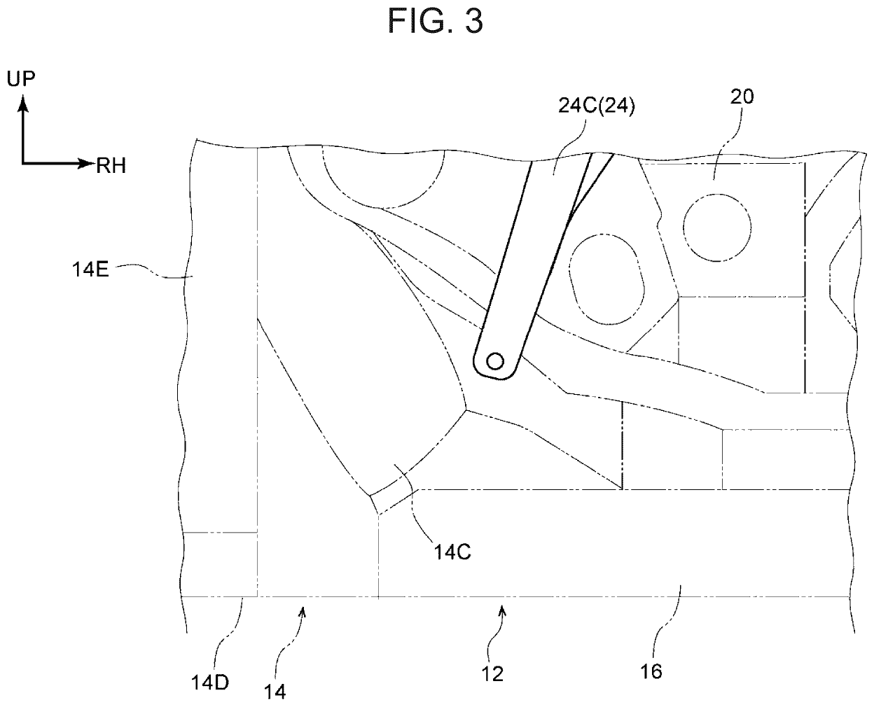

Specifically, as also shown in FIG. 3, the dash panel 20 has a plate shape in which the thickness direction is the vehicle front-rear direction and extends in the vehicle width direction and the vehicle up-down direction, and is formed of a steel plate or the like that is press-processed. The dash panel 20 is attached to the front part 12 by an attachment member (not shown).

The cowl portion 22 extends in the vehicle width direction along the upper edge portion of the dash panel 20. A cowl lower panel (not shown), which is made of steel and constitutes the lower part of the vehicle, and a resin cowl top panel 30, which constitutes the upper part of the vehicle, are included.

The cowl lower panel includes a main body portion which constitutes a main portion thereof and has a U-shape in which the vehicle upper side is opened, and a flange portion which extends from the upper edge portion of the main body portion to each of the vehicle front side and the vehicle rear side. The cowl lower panel is attached to the pair of side components 14 via attachment members (not shown) in a state where the cowl lower panel is bridged between them. Then, the cowl top panel 30 covers the vehicle upper side of the cowl lower panel.

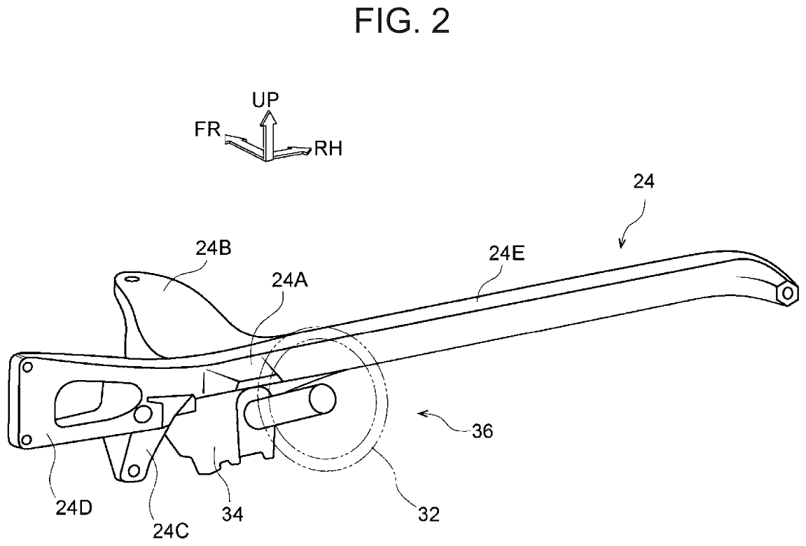

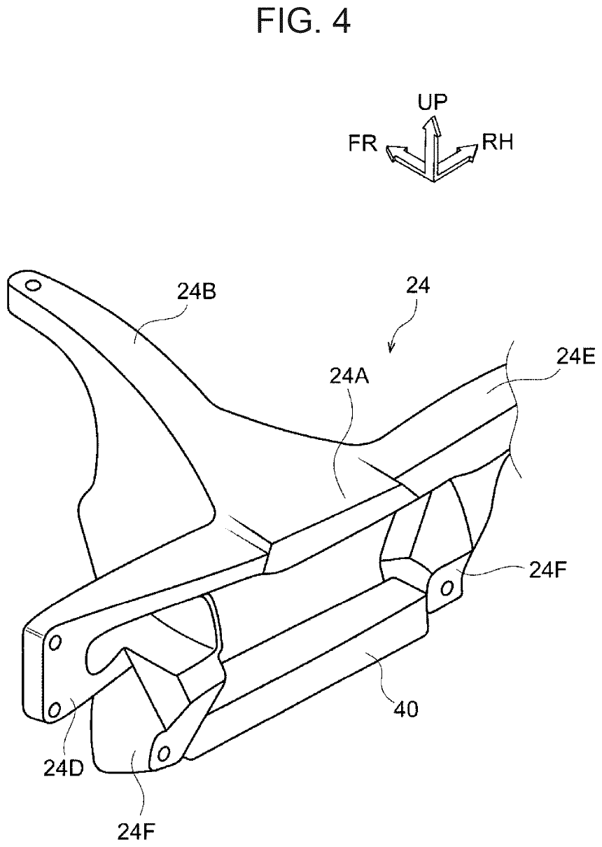

The instrument panel reinforcement 24 is made of resin. As also shown in FIG. 2 and FIG. 4, it is configured to include a “support portion 24A” as a first support portion, an “extension portion 24B” as a second support portion, an “extension portion 24C” as a third support portion, an “extension portion 24D” as a fourth support portion, an “extension portion 24E”, and “support portions 24F” as fifth support portions.

The support portion 24A supports a “steering device 36” which is disposed on the front side of the “driver's seat S” and includes a steering wheel 32 and a “steering column 34”.

The extension portion 24B extends from the support portion 24A toward the vehicle front upper side, and an end portion of the vehicle front side is attached to a portion of the main body portion of the cowl lower panel on the vehicle rear side via a mounting member (not shown).

The extension portion 24C extends from the support portion 24A to the lower side of the vehicle, and as shown in FIG. 3, the distal end portion thereof is attached to the dash panel 20 by an attachment member (not shown).

The extension portion 24D extends from the support portion 24A to the left side in the vehicle width direction, and a distal end portion thereof is attached to the lower pillar portion 14E on the left side in the vehicle width direction by an attachment member (not shown).

The extension portion 24E extends from the support portion 24A to the right side in the vehicle width direction, and a distal end portion thereof is attached to the lower pillar portion 14E on the right side in the vehicle width direction by a mounting member (not shown).

As illustrated in FIG. 4, the support portions 24F extend from the support portion 24A toward the vehicle lower side, and are arranged in a pair at intervals in the vehicle widthwise direction. A “knee airbag device 40” as an airbag device is supported on the support portions 24F.

In the present embodiment, the steering device 36 is disposed on the left side in the vehicle width direction, and the vehicle 10 is a so-called left steering vehicle, but the steering device 36 may be disposed on the right side in the vehicle width direction. That is, the steering device support structure according to the present embodiment can also be applied to a vehicle having a right steering wheel by having the configuration of the instrument panel reinforcement 24 symmetrical with respect to the configuration described above in the vehicle width direction.

### Actions and Effects of Embodiment

Next, actions and effects of the embodiment will be described.

In the present embodiment, as shown in FIG. 1 and FIG. 2, an instrument panel reinforcement 24 including a support portion 24A, an extension portion 24B, an extension portion 24C, and an extension portion 24D is provided.

Specifically, the support portion 24A supports the steering column 34 disposed on the vehicle front side of the driver's seat S of the vehicle. Further, the extension portion 24B is integrally provided with the support portion 24A and is supported by the vehicle body 11 on the vehicle upper side of the support portion 24A. Further, the extension portion 24C is integrally provided with the support portion 24A and is supported with respect to the vehicle body 11 on the vehicle lower side of the support portion 24A. The extension portion 24D is integrally provided with the support portion 24A and is supported by the vehicle body 11 on the vehicle widthwise outer side of the support portion 24A.

As described above, in the present embodiment, the steering column 34 can be supported with respect to the vehicle body 11 by the instrument panel reinforcement 24.

In the present embodiment, the instrument panel reinforcement 24 is made of resin. Therefore, compared with a configuration in which the instrument panel reinforcement 24 is made of metal, it is possible to reduce the cost of manufacturing the instrument panel reinforcement 24.

Further, in the present embodiment, the extension portion 24D and the extension portion 24E extending away from the extension portion 24D are supported by the vehicle body 11, and the instrument panel reinforcement 24 is bridged with respect to the vehicle body 11 in the vehicle widthwise direction. In the present embodiment, as also shown in FIG. 4, the support portions 24F extend from the support portion 24A, and the knee airbag device 40 is supported on the support portions 24F.

Therefore, in the present embodiment, the reaction force at the time of deployment of the airbag can be supported by the vehicle body 11 via the instrument panel reinforcement 24, and the number of components required for supporting the knee airbag device 40 can be reduced.

In addition, in the present embodiment, the instrument panel reinforcement 24 can be supported by a portion of the vehicle body 11 having a higher stiffness, that is, the cowl portion 22, the dash panel 20, the front pillar portion 11A, and the front pillar portion 11B located on the vehicle-width-direction opposite side to the front pillar portion 11A. Therefore, in the present embodiment, it is possible to secure a reaction force against an input to the steering wheel 32.

As described above, according to the steering device support structure of the present embodiment, the number of components required for supporting the steering device 36 can be reduced.

What is claimed is:

1. A steering device support structure comprising an instrument panel reinforcement, wherein the instrument panel reinforcement includes:
a first support portion that supports a steering column arranged on a vehicle front side of a driver's seat of a battery electric vehicle;
a second support portion integrally provided with the first support portion and supported by a vehicle body of the battery electric vehicle on a vehicle upper side of the first support portion;
a third support portion integrally provided with the first support portion and supported by the vehicle body on a vehicle lower side of the first support portion; and
a fourth support portion integrally provided with the first support portion and supported by the vehicle body on a vehicle width direction outer side of the first support portion.

2. The steering device support structure according to claim 1, wherein the instrument panel reinforcement is made of resin.

3. The steering device support structure according to claim 1,
wherein the instrument panel reinforcement further includes an extension portion that extends from the first support portion to an opposite side to the fourth support portion and is supported by the vehicle body, and
wherein an airbag device is supported by a fifth support portion extended from the first support portion.

4. The steering device support structure according to claim 3,
wherein the second support portion is supported by a cowl skeleton portion that constitutes a portion of the vehicle body,
wherein the third support portion is supported by a dash panel that constitutes a portion of the vehicle body,
wherein the fourth support portion is supported by a first pillar portion that constitutes a portion of the vehicle body, and
wherein the extension portion constitutes a portion of the vehicle body and is supported by a second pillar portion positioned on an opposite side to the first pillar portion in a vehicle width direction.
